(19) United States
(12) Patent Application Publication
(10) Pub. No.: US 2026/0352739 A1
(43) Pub. Date: Nov. 5, 2026

(54) SYSTEM AND METHOD FOR NEAR REAL-TIME PERFORMANCE GAP ANALYSIS AND PERFORMANCE OPTIMIZATION OF CONTENT PLATFORMS

(71) Applicant: Moonshot AI Inc, New York, NY (US)

(72) Inventors: Evyatar SEGAL, Hoboken, NJ (US); Aviv Moshe FRENKEL, Tel Aviv (IL)

(73) Assignee: Moonshot AI Inc, New York, NY (US)

(21) Appl. No.: 19/195,103

(22) Filed: Apr. 30, 2025

(51) Int. Cl. H04L 67/50; G06F 11/34; G06F 16/957; G06Q 30/0202; G06Q 30/0242

(52) U.S. Cl. CPC H04L 67/535; G06F 11/34; G06F 16/9574; G06Q 30/0202; G06Q 30/0246

(57) ABSTRACT

A system and method for utilizing gap analysis in web content optimization is presented. The method includes accessing a plurality of network traffic funnels, each network traffic funnel based on a target outcome of a plurality of outcomes; detecting at least one first target outcome of a first type and a second target outcome of the first type; detecting a performance gap based at least on a plurality of user interactions associated with a network traffic funnel associated with the second target outcome and a benchmark value of a content performance metric; generating a performance gap analysis report based on a predefined markup language template and the detected performance gap; and sending over a network interface the generated performance gap analysis report to a client device.

### TECHNICAL FIELD

The present disclosure relates generally to improving the performance of a content platform, and specifically to determining the gap analysis in such platforms in near real-time.

### BACKGROUND

Gap analysis in the context of a content platform involves assessing the disparities between the current performance and desired objectives of the content of the content platform. This systematic approach helps identify areas needing improvement to enhance user experience, operational efficiency, and overall profitability.

The gap analysis process is typically conducted by a team comprising various stakeholders, including business analysts, IT professionals, marketing strategists, and user experience designers. Their collective expertise ensures a comprehensive evaluation of the web content's functionality, user engagement, and overall effectiveness.

The team begins by defining the web content's strategic goals, such as increasing conversion rates, enhancing user satisfaction, or expanding market reach. Subsequently, they gather and analyze data on current content performance metrics, including website traffic, bounce rates, and sales figures. This analysis helps pinpoint specific areas where the website is underperforming, i.e., gaps. For instance, a high bounce rate might indicate issues with site navigation or content relevance.

Once the gaps are identified, the team delves into root cause analysis to understand the underlying issues. This could involve examining technical aspects like page load speeds, assessing the effectiveness of marketing campaigns, or evaluating the clarity of product information. Based on these insights, the team develops targeted action plans to bridge the gaps, such as implementing responsive design improvements, optimizing content for search engines, or enhancing the checkout process.

Continuous monitoring and iterative improvements are essential to ensure that implemented changes effectively move a content website toward its desired performance levels. However, a significant technical challenge arises from the reliance on manual analysis, often performed on outdated data. This manual approach hinders the timely detection of performance gaps, delaying the implementation of corrective measures. Manually analyzing market gaps may not always provide the most accurate and up-to-date insights due to the dynamic nature of web data. Furthermore, content platforms face challenges in continuously monitoring on the fly and comparing data against competitors for optimization and improvement.

Tools such as Google Analytics and Hotjar deliver user behavior analytics, allowing for the manual identification of user experience issues; such tools, however, do not provide instance comparisons to a benchmark to determine a gap. To conduct an accurate gap analysis, a proper benchmark must be established. Existing solutions typically do not provide sufficient information to establish this benchmark, as typically they are based on outdated information or limited data sources. Additionally, using such tools in connection with a manual identification of gaps is limited due to the large number of possible combinations of parameters required for manual evaluation, rendering such manual solutions impractical to offer an operable solution.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include accessing a plurality of network traffic funnels, each network traffic funnel based on a target outcome of a plurality of outcomes. The method may also include detecting at least one first target outcome of a first type and a second target outcome of the first type. The method may furthermore include detecting a performance gap based at least on a plurality of user interactions associated with a network traffic funnel associated with the second target outcome and a benchmark value of a content performance metric. The method may in addition include generating a performance gap analysis report based on a predefined markup language template and the detected performance gap. The method may moreover include sending over a network interface the generated performance gap analysis report to a client device. Other embodiments of this aspect include corresponding computer systems, apparatus, and computer programs recorded on one or more computer storage devices, each configured to perform the actions of the methods.

Implementations may include one or more of the following features. The method may include: generating a modified content based on the second target outcome and the a generated benchmark value. The method may include: generating the benchmark value of a content performance metric based at least on a plurality of user interactions associated with each network traffic funnel associated with the at least one first target outcome. The method may include: receiving the benchmark value of a content performance metric from a benchmark database. The method may include: generating usage groupings based on a plurality of usage attributes for each user interaction associated with each network traffic funnel of the plurality of network traffic funnels. The method may include: extracting a plurality of usage attributes for each user interaction associated with each network traffic funnel; embedding a feature vector representing the plurality of usage attributes for each user interaction into a multi-dimensional feature space; and segmenting each network traffic funnel based on feature similarity between the feature vectors. The method may include: detecting a performance gap based on a first usage grouping associated with a first type and the a generated benchmark value, where the generated benchmark value is further based on at least one second usage grouping associated with the first type. The method may include: identifying an usage pattern associated with a plurality of user interactions; and detecting a network traffic funnel for each identified usage pattern. The method where user interactions are recorded in a plurality of activity records. The method where user interactions include at least one of: a number of webpages visited, an amount of time spent on each webpage, an interaction with a content, a session ID, a heatmap, and any combination thereof. The method where the target outcome includes at least one of: a click-through event, a form submission, a commitment of a transaction, a content share, a subscription, or a session duration threshold. The method where the content performance metric includes at least one of: conversion rate, average time to conversion, bounce rate, or drop-off rate at a funnel step. The method where generating the benchmark value of the content performance metric based at least on the a first plurality of user interactions associated with each network traffic funnel associated with the at least one first target outcome, further may include: computing, for each network traffic funnel associated with the at least one first target outcome, a content performance metric value; and aggregating the content performance metric values of each network traffic funnel associated with the at least one first target outcome. Implementations of the described techniques may include hardware, a method or process, or a computer-tangible medium.

In one general aspect, a non-transitory computer-readable medium may include one or more instructions that, when executed by one or more processors of a device, cause the device to: access a plurality of network traffic funnels, each network traffic funnel based on a target outcome of a plurality of outcomes; detect at least one first target outcome of a first type and a second target outcome of the first type; detect a performance gap based at least on a plurality of user interactions associated with a network traffic funnel associated with the second target outcome and a benchmark value of a content performance metric; generate a performance gap analysis report based on a predefined markup language template and the detected performance gap; and send over a network interface the generated performance gap analysis report to a client device. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: access a plurality of network traffic funnels, each network traffic funnel based on a target outcome of a plurality of outcomes. The system may in addition detect at least one first target outcome of a first type and a second target outcome of the first type. The system may moreover detect a performance gap based at least on a plurality of user interactions associated with a network traffic funnel associated with the second target outcome and a benchmark value of a content performance metric. The system may also generate a performance gap analysis report based on a predefined markup language template and the detected performance gap. The system may furthermore send over a network interface the generated performance gap analysis report to a client device. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: generate a modified content based on the second target outcome and a generated benchmark value. The system where the memory contains further instructions which when executed by the processing circuitry further configure the system to: generate the benchmark value of a content performance metric based at least on a plurality of user interactions associated with each network traffic funnel associated with the at least one first target outcome. The system where the memory contains further instructions which when executed by the processing circuitry further configure the system to: receive the benchmark value of a content performance metric from a benchmark database. The system where the memory contains further instructions which when executed by the processing circuitry further configure the system to: generate usage groupings based on a plurality of usage attributes for each user interaction associated with each network traffic funnel of the plurality of network traffic funnels. The system where the memory contains further instructions which when executed by the processing circuitry further configure the system to: extract a plurality of usage attributes for each user interaction associated with each network traffic funnel; embed a feature vector representing the plurality of usage attributes for each user interaction into a multi-dimensional feature space; and segment each network traffic funnel based on feature similarity between the feature vectors. The system where the memory contains further instructions which when executed by the processing circuitry further configure the system to: detect a performance gap based on a first usage grouping associated with a first type and the a generated benchmark value, where the generated benchmark value is further based on at least one second usage grouping associated with the first type. The system where the memory contains further instructions which when executed by the processing circuitry further configure the system to: identify an usage pattern associated with a plurality of user interactions; and detect a network traffic funnel for each identified usage pattern. The system where user interactions are recorded in a plurality of activity records. The system where user interactions include at least one of: a number of webpages visited, an amount of time spent on each webpage, an interaction with a content, a session ID, a heatmap, and any combination thereof. The system where the target outcome includes at least one of: a click-through event, a form submission, a commitment of a transaction, a content share, a subscription, or a session duration threshold. The system where the content performance metric includes at least one of: conversion rate, average time to conversion, bounce rate, or drop-off rate at a funnel step. The system where the memory contains further instructions that, when executed by the processing circuitry for generating the benchmark value of the content performance metric based at least on the a first plurality of user interactions associated with each network traffic funnel associated with the at least one first target outcome, further configure the system to: compute, for each network traffic funnel associated with the at least one first target outcome, a content performance metric value; and aggregate the content performance metric values of each network traffic funnel associated with the at least one first target outcome. Implementations of the described techniques may include hardware, a method or process, or a computer-tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram of a system utilized to demonstrate the various disclosed embodiments.

FIG. 2 is an example flowchart of a method for utilizing gap analysis in near real-time optimization of web content according to an embodiment.

FIG. 3 is an example flowchart of a method for computing benchmark values for content platforms in near real-time.

FIG. 4 is an example schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for near real-time analysis of content platforms to determine performance gaps in a content platform and optimize performance of the content platform by implementing automatic content modifications to the content platform based on the determined performance gaps. Hereinafter, near real-time refers to data processing and response delivery that occurs with minimal but non-zero delay that is acceptable to provide a practical solution distinguishable from real-time which refers to operating with virtually no latency to meet strict timing constraints. The disclosed embodiments include the dynamic computation of benchmark values that correspond to particular content performance metric values of the content platform. Benchmark values are computed dynamically to account for seasonal trends, market slowdowns, significant industry shifts (e.g., a major competitor launches a large-scale marketing campaign), and the like. Benchmarks values and corresponding content performance metric values for the content platform are computed based on near real-time analysis of usage data.

The usage data is also used to identify various network traffic funnels. A network traffic funnel is a series of steps a user navigates in a content platform to reach a target outcome. Identifying network traffic funnels provides an in-depth analysis of user activity through the steps of the identified network traffic funnels. This in-depth analysis includes the computation of content performance metric values and respective benchmark values such as, but not limited to, conversion rate and drop-off rate (both defined below). Usage data also allows usage groupings to be generated. Usage groupings are clusters of usage activity with similar attributes. Determining content performance metric values and benchmark values based on segmented usage data (usage groupings) provides a more precise analysis of performance gaps and, in turn, allows for more precise and relevant modifications to be implemented to content of webpages in a content platform.

Additionally, in some embodiments, near real-time analysis of content performance metric values is performed across different usage groupings to allow for modifications to the nature, scope, and timing of advertising efforts to generate traffic to a content platform. The near real-time analysis of content performance metric values across different usage groupings is a segmented analysis in which the content performance metric values for the same content platform are compared across different usage groupings. This segmented analysis allows the identification of certain usage groupings (characterized by similar users, devices, locations, traffic sources, time, a combination thereof, and the like) that have higher content performance metric values than other usage groupings. An owner of the content platform may, in near real-time, tailor advertising efforts to target the usage groupings that have the higher content performance metric values, maximizing revenue for the content platform.

In some embodiments, various AI tools are used to determine semantic similarity between content platforms, allowing the performance of the content platform to be compared to the benchmark performance of relevant content platforms (e.g., competitors, industry). Additionally, in some embodiments, various generative AI tools are used to recommend modifications to the contents of webpages of the content platform based on a determined performance gap.

In some embodiments, unlike solutions that require manual tracking, the disclosed method and system continuously scan and compare the content platform's performance to the performance of competitors (through benchmark values) in near real-time to ensure instant identification of pricing shifts, stock availability, promotions, industry trends, and the like. Compared to a computer, a human may be limited in effectively determining performance gaps of a content platform according to the various disclosed embodiments because of the scale, speed, and complexity of data processing required by the disclosed embodiments. The massive volume of usage data and platform data across multiple content platforms makes manual analysis slow, error-prone, impractical, and the like. Additionally, the market of content platforms changes rapidly, and by the time a human identifies a trend, it may already be outdated.

In various embodiments, the disclosed method and system enhance computer performance by optimizing how data is processed and analyzed. Instead of relying on traditional, resource-heavy batch processing, the method and system leverage near real-time data streaming to detect performance gaps instantly. By structuring data more efficiently (e.g., by computing near real-time, precise benchmark values and by generating usage groupings) and prioritizing relevant comparisons, the method and system may reduce unnecessary computations, minimize latency, improve the overall responsiveness of the system, and the like. In an embodiment, the method and system enable more efficient memory and CPU usage, allowing the computer to operate faster and handle large-scale data analysis without performance bottlenecks.

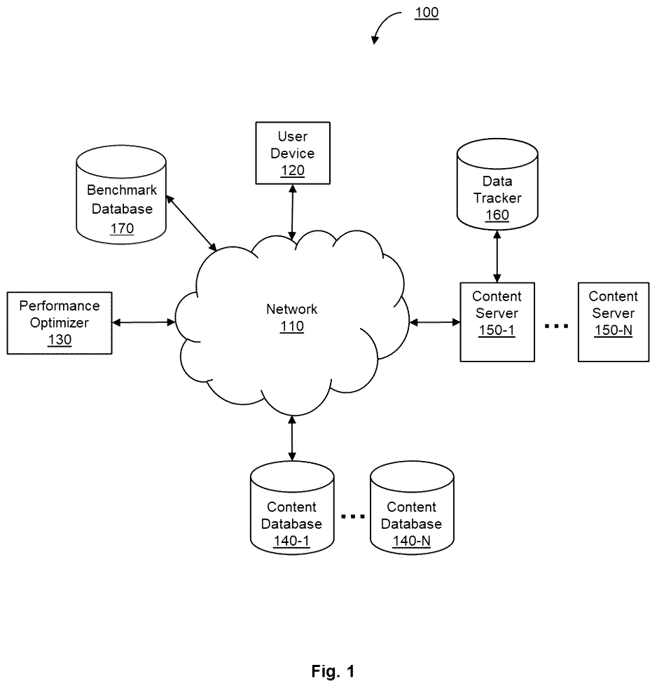

FIG. 1 is an example network diagram of a system 100 utilized to demonstrate the various disclosed embodiments. The network diagram 100 includes a plurality of user devices 120 (collectively referred to as devices 120 or a device 120), content servers 150-1 through 150-N (hereinafter, content server 150 or content servers 150), content database 140-1 through 140-N (hereinafter, content database 140 or content databases 140), performance optimizer 130, data tracker 160, and benchmark database 170 all connected to a network 110.

In an embodiment, a content server 150 is configured to provide web content over a network 110. A content server 150 includes, for example, a web server application, a proxy server application, a load balancer application, a combination thereof, and the like.

In an embodiment, a web server application is implemented, for example, using Nginx®. In an embodiment, the content server 150 is configured to generate web content, for example, from a plurality of contents stored on a content database 140. According to an embodiment, a content is a text, a graphic, a video, a graphical user interface (GUI) element, a combination thereof, and the like.

In an embodiment, a user device 120 requests a web content from the content server 150 over the network 110. In an embodiment, the network 110 includes a wireless, cellular or wired network, a local area network (LAN), a wide area network (WAN), a metro area network (MAN), the Internet, the worldwide web (WWW), similar networks, and any combination thereof.

In some embodiments, the user device 120 is a personal computer, a laptop, a tablet computer, a smartphone, a wearable computing device, an internet of things (IoT) device, a device capable of receiving and displaying notifications, a combination thereof, and the like.

In some embodiments, a content server 150 is a software system that stores, processes, and serves web content to users by handling client requests over the internet. As a non-limiting example, when a user makes an HTTP or HTTPS request, the web server processes the request, retrieves the requested resources (e.g., HTML pages, images, API requests), and delivers the resource back to the user. According to an embodiment, the content server 150 hosts a content platform.

In some embodiments, content platform includes, but is not limited to, a business-to-business (B2B) platform, business-to-consumer (B2C) platform, consumer-to-consumer (C2C) platform, consumer-to-business (C2B) platform, and the like. Content platform may further include a website, a webpage, an online platform, a digital marketplace, and the like.

According to an embodiment, it is advantageous to provide a user of the user device 120 with a content which they are likely to interact with. For example, it is advantageous in certain embodiments to provide a user of the user device 120 with a web page where the user is more likely to initiate a transaction, request additional content, engage with a web content, a combination thereof, and the like.

However, a provider of the web content may not always supply the content in the most engaging way possible. Furthermore, different users may interact and respond differently to content depending on how it is presented.

In an embodiment, a user device 120 and a content server 150 are configured to engage in an activity session. For example, an activity session may include a transfer of requests from the user device 120 to the content server 150, a transfer of content from the content server 150 to the user device 120, network packets, data packets, an action initiated by the user device 120, a combination thereof, and the like.

For example, in an embodiment, an activity session includes a plurality of requests for content, an interaction of a user based on the received content, and the like. In an embodiment, the activity session is generated by a customer engagement platform (not shown) which is configured to generate a heatmap, detect behavior, perform behavior analysis, capture user interaction, detect user usage pattern, a combination thereof, and the like.

In an embodiment, data tracker 160 is configured to monitor and record data related to activity sessions between a plurality of user devices 120 with content server 150. In some embodiments, performance optimizer 130 is configured to retrieve data from the data tracker 160.

In some embodiments, a benchmark database 170 stores benchmark values. A benchmark value is a particular value of a content performance metric of a content platform that serves as an ideal performance value. The benchmark value may be an internal benchmark value, a competitive benchmark value, an industry benchmark value, a financial benchmark value, and the like.

An internal benchmark value is an ideal performance value based on the collection of content platform's historical data, internal goals, past performance, and the like, to assess the effectiveness of the content platform's processes, operations and strategies. A competitive benchmark value is an ideal performance value based on the performance of competitors of the content platform. An industry benchmark value is an ideal performance value based on the performance of content platforms in the broader industry, including competitors. A financial benchmark value is an ideal performance value based on key financial indicators.

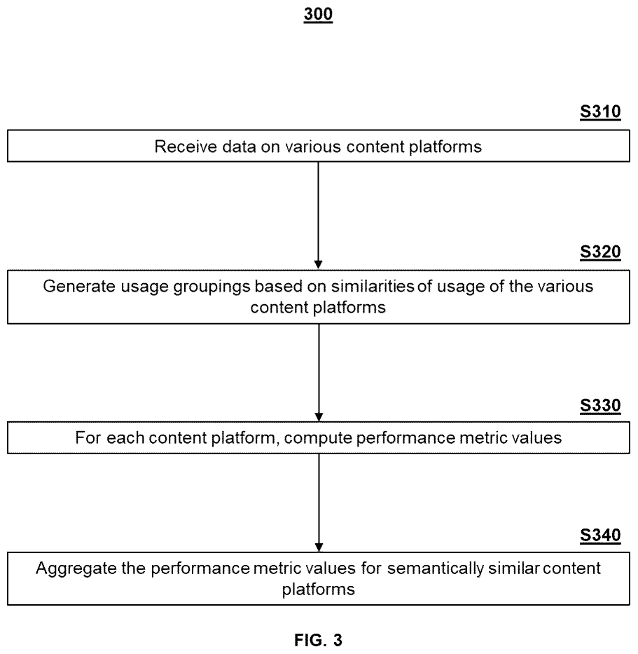

The benchmark values stored in benchmark database 170 may be computed in near real-time and dynamically updated based on new data, as discussed in detail below with reference to FIG. 3. In another embodiment, benchmark values are computed based on analytics gathered from data tracker 160. Data trackers 160 may include Google® analytics, Adobe® analytics, and the like.

In one embodiment, benchmark database 170 is configured to retrieve benchmark values from an open-source database (not shown). Performance optimizer 130 may periodically connect to the open-source database. Upon establishing a connection, performance optimizer 130 transmits one or more queries to the open-source database, where such queries are constructed to request benchmark values for specific web content or categories of web content. Once benchmark values are retrieved from open-source database, the benchmark values are stored in the benchmark database 170. In some embodiments, performance optimizer 130 may utilize a synchronization mechanism that automatically checks for updates to the open-source database at predetermined intervals.

In some embodiments, performance optimizer 130 receives tracking codes and analytics data from data trackers 160. The tracking codes and analytics data are used to identify network traffic funnels and user behavior in content platforms. In an embodiment, a content platform integrates analytics tools, such as Google Analytics, Adobe® Analytics, JavaScript® event tracking, and the like, to monitor user interactions in real time. In some embodiments, a tracking script downloaded from on the content platform to a user's browser (or mobile app) to record a user's visits on the site, capturing actions such as viewing a product, adding an item to the cart, reaching checkout, and the like. In various embodiments, the collected data is sent to analytics platforms through background data requests (e.g., HTTP requests).

In some embodiments, performance optimizer 130 receives benchmark values from benchmark database 170. Performance optimizer 130 also receives activity records from content server 150 regarding the usage of a content platform. Activity records include, but are not limited to, user actions (e.g., clicks, scrolls, item view), information from devices (e.g., IP addresses, browser types), analytics data (e.g., user behavior patterns, conversion rates), and the like from content server 150.

Performance optimizer 130 identifies network traffic funnels in a content platform. As noted above, A network traffic funnel is a series of steps a user navigates in a content platform to reach a target outcome. As a non-limiting example, a network traffic funnel may include steps such as viewing a homepage, clicking on a product, adding the product to a virtual cart, and purchasing the product. The target outcome of a network traffic funnel may be, in an embodiment, time-based metric, e.g., to increase time spent on a website by a certain threshold. In certain embodiments, the target outcome of a network traffic funnel is an engagement-based metric, e.g., to increase an amount of interaction with follow-on content, or to increase an amount of requests from user devices to commit a transaction in a database managed by a provider of the content platform.

Performance optimizer 130 receives various content performance metric values associated with network traffic funnels in a content platform. Content performance metrics include, but are not limited to, conversion rate, drop-off rate, and other key performance indicators (KPIs). A conversion rate is defined as a percentage of users whose user traffic through a network traffic funnel leads to the purchase of a good of service through a content platform. A drop-off rate is defined as a percentage of users whose user traffic does not continue from one step of a network traffic funnel to a subsequent step of the network traffic funnel. KPIs may include, but are not limited to, bounce rate (e.g., users who land on a webpage and leave without taking any further action), cart abandonment rate, click-through (e.g., user clicking on a specific link, button, or ad to navigate to another page within a website), average session duration, customer acquisition cost, and returning vs. new visitors.

Performance optimizer 130 is configured to identify and analyze performance gaps in network traffic funnels in a content platform. In some embodiments, performance optimizer 130 compares a content performance metric value associated with a network traffic funnel in content platform to a respective benchmark value, in near real-time. According to this embodiment, a benchmark value may be a benchmark conversion rate for network traffic funnels that are sufficiently similar to the analyzed network traffic funnel. According to this embodiment, a benchmark value may be a past conversion rate for the analyzed network traffic funnel. For example, for a particular network traffic funnel, the current conversion rate is 2.5%, while the benchmark conversion rate is 5%. In this example, the performance gap, for the particular network traffic funnel, is measured as the difference (2.5%) between the conversion rate and the benchmark conversion rate. In some embodiments, performance optimizer 130 compares drop-off rates for transitions between steps in each network traffic funnel in a content platform to benchmark values. According to this embodiment, a benchmark value is a benchmark drop-off rate for transitions between steps of a network traffic funnel that are sufficiently similar to the transitions between steps in the analyzed network traffic funnel.

In an embodiment, the performance optimizer 130 is further configured to cluster activity sessions into usage groupings. For example, the performance optimizer 130 is configured, in an embodiment, to generate usage groupings based on a predetermined value, range of values, etc., of an attribute of an activity session.

Usage groupings are based on similarities in the usage of various content platforms. Usage activities are grouped together when the usage activities have sufficiently similar attributes. Attributes include, but are not limited to, the user's device type (e.g., mobile vs. desktop), screen size, traffic source (e.g., Google® search, advertisements, social media), geographical location (e.g., country, state, city), user status (e.g., returning vs. new), visit frequency (e.g., daily, weekly, monthly), and the like. In certain embodiments, an internet protocol address (IP) is utilized to track attributes from the user's activity.

In an embodiment, usage groupings are generated by first extracting a usage attributes for each user interaction associated with each network traffic funnel. Then, a feature vector representing the usage attributes for each user interaction is embedded into a multi-dimensional feature space. Each network traffic funnel is segmented into usage groupings, where each usage grouping is segmented based on feature similarity between the feature vectors.

Generating usage groupings allows performance optimizer 130 to determine performance gaps on content platforms per usage grouping. For example, new users from New York City that were directed to a content platform via Instagram® on iPhone® may be a usage grouping. According to this example, a content performance metric value for the usage grouping may also be determined, and a respective benchmark value for the usage grouping may be determined. By comparing the content performance metric value to the respective benchmark value for the usage grouping, a performance gap that is target for this specific usage grouping is determined. The determined performance gaps of a content platform for a specific usage grouping are more precise than performance gaps that are not determined per usage grouping. The increased precision of the performance gap allows for more effective recommendations for modifications to the content along a particular network traffic funnel on a content platform.

In certain embodiments, the performance optimizer 130 is configured to receive, access, etc., content from the content database 140, and generate a web content (e.g., an HTML page) for providing a user device 120. In an embodiment, the performance optimizer 130 is configured to generate the web content further based on a metric objective. In some embodiments, the performance optimizer 130 is configured to generate a unique web content for each usage grouping.

According to an embodiment, the performance optimizer 130 is further configured to generate a web content by utilizing an AI model, including but not limited to, a generative AI model. In an embodiment, the generative AI model includes a generative adversarial network (GAN), a generative pre-trained transformer (GPT), a BART model, a LLaMa model, a language model (e.g., a large language model, a small language model, etc.), a multimodal generative AI, a combination thereof, and the like.

In an embodiment, the performance optimizer 130 is configured to generate a prompt for the generative AI model. For example, in an embodiment, the prompt includes an instruction to generate a web content based on a content accessed from the content database 140, a constraint based on a determined metric, a prompt template, a combination thereof, and the like. In an embodiment, the performance optimizer 130 is configured to select a prompt template from a plurality of prompt templates based, for example, on a classification of the content from the content database 140.

In some embodiments, performance optimizer 130 automatically recommends modifications to the contents of content platform based on the determined performance gaps. In some embodiments, generating usage groupings and analyzing gaps between content performance metric values and respective benchmark values for a specific usage grouping allows for more accurate recommendations. Additionally, determining the drop-off rates in transitions between steps in a network traffic funnel and respective benchmark drop-off rates allows a precise determination of which particular transition between steps along the network traffic funnel lost the most users compared to a benchmark value. This precise determination allows for the targeting of particular content in a step along the network traffic funnel that may have contributed to users exiting the network traffic funnel.

In some embodiments, performance optimizer 130 may recommend a modification to components of a display (e.g., graphical user interface) on a particular web page of commerce platform on a personal computer, tablet, smartphone, and the like. The display may include components such as, but not limited to, a static picture, text content, a hyperlink, and an interface button. The modification to the display may include modifying a component, modifying a position of a component relative to the display, modifying a color of a component, modifying a font of a textual content, modifying a size of a component, a combination thereof, and the like. Such modifications are recommended to improve the performance of a network traffic funnel of content platform by bringing a content performance metric value of the network traffic funnel closer to a respective benchmark value for the network traffic funnel.

As a non-limiting example, a performance gap may be determined based on a drop-off rate from a product page to an add-to-cart page that falls below a respective benchmark drop-off rate. Based on this performance gap, performance optimizer 130 may recommend modifications to the components on the display of the product page such as, but not limited to, increasing the size of the add-to-cart button on the product page; changing the relative position of the add-to-cart button; changing the color of the add-to-cart button; changing the text in the add-to-cart button from, for example, “add to cart” to “add to cart (before it's gone)”, and queuing a product demonstration video upon a user entering the product page.

In some embodiments, performance optimizer 130 may automatically recommend the modifications to the components of the display of one or more web pages based on an identified performance gap. In some embodiments, performance optimizer 130 may automatically modify the components of the display according to the recommended modifications without any human intervention.

It should be understood that the embodiments described herein are merely exemplary and not intended to be limiting. The arrangement illustrated in FIG. 1 is provided for illustrative purposes only and does not restrict the scope of the disclosed embodiments. Various modifications, adaptations, and alternative configurations may be implemented without departing from the spirit and scope of the disclosed embodiments.

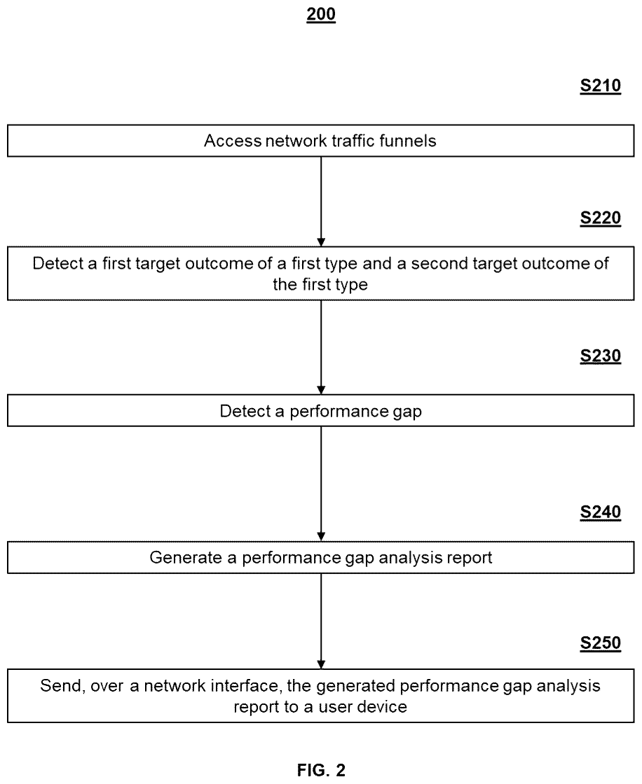

FIG. 2 is an example flowchart 200 of a method for utilizing gap analysis in near real-time optimization of web content according to an embodiment. The method may be performed by the performance optimizer 130, shown in FIG. 1. Optimizing the performance of content platforms includes modifying content to ensure performance gaps between the content performance metric values and respective benchmark values are reduced.

At S210, network traffic funnels are accessed. As mentioned above, a network traffic funnel is a series of steps a user navigates in a content platform to reach a target outcome.

In some embodiments, network traffic funnels are accessed by continuously tracking users of user devices (e.g., user devices 120) over the content platform hosted on a web server (e.g., content server 150). As a non-limiting example, when a user of a user device accesses a content platform, a script is downloaded to the user device. The script can monitor and record the interactions or actions of the user on the content platform. The recorded actions are processed by using tracking tools like Google® Analytics, Adobe® Analytics, JavaScript® event tracking, and the like, where the data is analyzed to understand user's behavior on the content platform.

In an embodiment, as mentioned above, content platforms enable analytics tools, tracking codes, event listeners, and the like to track, record, and analyze on the fly user activities for analytical purposes. In various embodiments, some content platforms share analytics data publicly through methods like public Google Analytics dashboards, Google Search Console Insights, and third-party tools like SimilarWeb and SEMrush that estimate traffic on content platforms.

In an embodiment, as a non-limiting example, network traffic funnels may be accessed by Google Analytics to track user activity at each stage of the conversion process. Google Analytics provides network traffic funnel visualization reports to highlight drop-offs, behavior flow to track navigation patterns, segmented analysis, and the like. According to an embodiment, data from content platforms may also be identified by integrating a tracking code by the content site, where the content enable the code, when executed on a user's browser, to track user activities for analytical purposes. In an embodiment, a tracking code identifies and records network traffic funnels, including how users move through a site, where a user drops off, what actions a user takes, and the like. In certain embodiments, a tracking code is a script, typically written in JavaScript® and embedded within a website's HTML, that collects and transmits user interaction data. In an embodiment, the tracking code is deployed with a user's permission and is commonly used for analytics, performance monitoring, behavioral tracking, and the like.

It should be noted that the tracking and collection of user activity data is performed on a continuous basis, enabling near-real-time identification of user interaction network traffic funnels as the data is acquired. This continuous monitoring enables the subsequent detection and analysis of performance gaps as they arise.

At S220, a first target outcome of a first type and a second target outcome of the first type are detected. In an embodiment, detecting a first target outcome and a second target outcome of the same type includes detecting network traffic funnels across different content platforms that are of the same type. For example, when a first target outcome and second target outcome both involve a purchase action sent by a user device, the type of these target outcomes may be a purchase action type. In an embodiment, detecting the first target outcome and the second target outcome of the same type allows for computing content performance metric values and benchmark values associated with network traffic funnels that are associated with target outcomes of the same type. Detecting target outcomes of the same type allow for accurate detection of gaps, as explained at S230.

At S230, a performance gap is detected. In an embodiment, the performance gap is detected based on a content performance metric value and a benchmark value of the content performance metric. According to this embodiment, the content performance metric value is based on user interactions associated with a network traffic funnel respective of the second target outcome, and a benchmark value of content performance metric is based on user interactions associated with each network traffic funnel respective of the first target outcome. Examples of content performance metrics are detailed above with respect to FIG. 1.

In some example embodiments, a content performance metric value may be a conversion rate. A conversion rate is computed by dividing the number of users who complete a target outcome (e.g., making a purchase) by the total number of users who initiated the process (e.g., visited a product page). The result is then multiplied by 100 to express the result as a percentage. For example, if 50 out of 500 visitors on a content platform complete a purchase, the conversion rate is 10%.

In some example embodiments, a content performance metric value may be a drop-off rate. A drop-off rate is computed by identifying the steps (e.g., web pages) of a network traffic funnel (e.g., home page→product page→add-to-cart page→checkout page→purchase page) and tracking how many users do not transition between steps of each network traffic funnel. The drop-off rate for each network traffic funnel is determined by dividing the number of users at a particular step of a network traffic funnel from the number of users at a preceding step of the network traffic funnel, then multiplying by 100. For a particular network traffic funnel, if a home page receives 10,000 users and 5,000 users transition to a product page, the drop-off rate for the transition between the home page and the product page of the particular network traffic funnel is 50%. If, of the 5,000 users on the product page, 2,500 users transition to an add-to-cart page, the drop-off rate for the transition between the product page and the add-to-cart page is 50%. If, of the 2,500 users on the add-to-cart page, 1,500 proceed to a checkout page, the drop-off rate for the transition between the add-to-cart page and the checkout page is 40%. If, of the 1,500 users on the checkout page, 1,000 users proceed to a payment page (e.g., complete the purchase), the drop-off rate for the transition between the checkout page and the payment page is 33.3%.

In some embodiments, a respective benchmark value when the content performance metric value is a drop-off rate for a transition between steps in a network traffic funnel is a benchmark drop-off rate for the same or a sufficiently similar transition between steps in a network traffic funnel. For example, if a drop-off rate (e.g., 50%) for a transition between a product page and an add-to-cart page on a fashion content platform on a mobile device is the content performance metric value, then a benchmark drop-off rate (e.g., 35%) for the same or similar transition between a product page and add-to-cart page on fashion content platforms on mobile devices is the respective benchmark value used for comparison to the determine a performance gap. The computation of benchmark values is discussed in more detail in FIG. 3.

In some embodiments, the benchmark value may be an internal benchmark value, an industry benchmark value, a competitive benchmark value, a financial benchmark value, and the like, as described in more detail above with respect to FIG. 1. The type of these different benchmark values is based on the source and type of data used to compute each type of benchmark value. For example, a competitive benchmark value is based on aggregated content performance metric values from a set of content platforms that are considered competitors to the content platform.

In some embodiments, benchmark values are computed by identifying content performance metric values associated with network traffic funnels in relevant content platforms and aggregating the content performance metric values. This embodiment is discussed in more detail in FIG. 3.

In some embodiments, performance gaps may be quantified based on the comparison of a computed content performance metric value to a respective benchmark value. In some embodiments, a performance gap is quantified as a percentage difference between the content performance metric value and the respective benchmark value. As a non-limiting example, if a content performance metric value is a drop-off rate of 50% and the respective benchmark drop-off rate is 35%, the performance gap is quantified as 15%.

In an embodiment, a performance gap may be quantified as an opportunity cost. An opportunity cost, according to this embodiment, refers to a monetary loss associated with a performance gap between a content performance metric value and a respective benchmark value. According to this embodiment, opportunity cost is quantified with respect to content performance metrics that are associated with a sale. Such content performance metrics may include, but are not limited to, a conversion rate for a network traffic funnel in which the target outcome of the network traffic funnel is a sale. For such a conversion rate, if the current conversion rate is 2% but the benchmark is 3%, the performance gap (conversion rate gap) is 1%. The opportunity cost of this conversion rate gap is quantified based on the conversion rate gap, the total number of users of the network traffic funnel associated with the conversion rate gap, and the cost of the good or service associated with the network traffic funnel. For example, for a content platform with 100,000 monthly visitors, a conversion rate gap of 1%, and a $50 cost of the good or service, the opportunity cost is quantified as $50,000 (1%*100,000*$50).

In some embodiments, performance gaps of a content platform are detected for a specific usage grouping. According to this embodiment, usage groupings are generated based on similarities in the usage attributes of user interactions associated with a particular network traffic funnel. Usage activities are grouped together when the activity sessions of users have sufficiently similar attributes. Attributes include, but are not limited to, the user's device type (e.g., mobile vs. desktop), screen size, traffic source (e.g., Google search, advertisements, social media), geographical location (e.g., country, state, city), user status (e.g., returning vs. new), visit frequency (e.g., daily, weekly, monthly), and the like. In certain embodiments, an internet protocol address (IP) is utilized to track attributes from the user's activity. As mentioned above, as a non-limiting example, new users from New York City that were directed to content platform via Instagram® on iPhone® may be a usage grouping.

In some embodiments, generating usage groupings allows the near real-time analysis of content performance metric values across different usage groupings. The near real-time analysis of content performance metric values across different usage groupings is a segmented analysis in which the content performance metric values for the same content platform is compared across different usage groupings. This segmented analysis allows the identification of certain usage groupings that have higher content performance metric values than other usage groupings. In an embodiment, this analysis allows the owner of a content platform to modify the nature, scope, and timing of advertisement campaigns designed to generate user traffic to the content platform.

As a non-limiting example, a conversion rate for a particular network traffic funnel on Nike®'s website may be higher for users based in New York City who were directed to Nike®'s website via Instagram® on a mobile device during a holiday season (first usage grouping) than for users based in Atlanta who were directed to Nike®'s website via TikTok® on a mobile device during the holiday season (second usage grouping. According to this example, Nike® may modify, in near real-time, the nature, scope, and timing of its advertising campaigns based on the difference in conversion rates between the two usage groupings. As an illustrative example, Nike® may, in near real-time, place a greater emphasis on advertising efforts, during the holiday season, for Instagram® mobile users based in New York City than for TikTok® mobile users based in Atlanta.

In an embodiment, usage groupings are generated by first extracting a usage attributes for each user interaction associated with each network traffic funnel. Then, a feature vector representing the usage attributes for each user interaction is embedded into a multi-dimensional feature space. Each network traffic funnel is segmented into usage groupings, where each usage grouping is segmented based on feature similarity between the feature vectors.

Determining performance gaps based on segmented analysis of usage groupings provides more precise analysis than determining performance gaps for all users (without using generated usage groupings). To determine such precise performance gaps based on specific usage groupings, content performance metric values and respective benchmark values are computed for each usage grouping. The increased precision of the performance gap allows for more effective recommendations for modifications to the web pages and components of web pages of particular network traffic funnels on a content platform.

At optional step S240, a performance gap analysis report is generated. In an embodiment, the performance gap analysis report is generated based on a predefined markup language template and the detected performance gap.

In one embodiment, the report is generated automatically in response to detecting a discrepancy between actual performance metrics and benchmark values associated with content distributed via a content platform. The generation of this report may be triggered by scheduled intervals, user requests, or specific thresholds of performance deviation.

In an embodiment, the performance gap analysis report is generated using a predefined markup language template, such as XML, JSON, or HTML, which includes structured placeholders for dynamic insertion of key data. Placeholders may include key data such, but not limited to, the specific content items under analysis, content performance metric values, corresponding benchmark values, magnitude and direction of each detected gap, suggested corrective actions, timestamp information, a combination thereof, and the like.

In some embodiments, the markup langue template may be customizable, enabling the configuration of the structure and level of detail included in the report according to user preference.

At optional step S250, the generated performance gap analysis report is sent, over a network interface, to a user device.

In an embodiment, the network interface may include, but is not limited to, a wireless, cellular or wired network, a local area network (LAN), a wide area network (WAN), a metro area network (MAN), the Internet, the worldwide web (WWW), similar networks, and any combination thereof. The transmission of the performance gap analysis report may be initiated in ways such as, but not limited to, automatically upon report generation, in response to a user request via a web interface or mobile app, according to a scheduled reporting interval (e.g., daily, weekly, etc.), based on the detection of a performance gap, a combination thereof, and the like.

The user device may include a personal computer, a laptop, a tablet computer, a smartphone, a wearable computing device, an internet of things (IoT) device, a device capable of receiving and displaying notifications, a combination thereof, and the like.

In an embodiment, for each determined performance gap, a modified content is generated based on the respective performance gap. Modifications to the content platform are discussed above in FIG. 1 with respect to modifications to content platform by performance optimizer 130. The nature of the modifications to the content platform is based on the type and size of the performance gap. For example, if there is a 15% performance gap in a drop-off rate for a transition between a product page and an add-to-cart page for the content platform, the product page may be modified in various ways (as explained in more detail in FIG. 1) to close the performance gap. Closing the performance gap serves to optimize the performance of the content platform.

Although FIG. 2 shows example blocks of flowchart 200, in some implementations, flowchart 200 may include additional blocks, fewer blocks, different blocks, or differently arranged blocks than those depicted in FIG. 2. Additionally, or alternatively, two or more of the blocks of flowchart 200 may be performed in parallel.

FIG. 3 is an example flowchart 300 of a method for computing benchmark values for content platforms in near real-time. In an embodiment, benchmark values are computed by performance optimizer 130, FIG. 1. In an embodiment, benchmark values are stored in benchmark database 170, FIG. 1. In some embodiments, benchmark values are computed in near real-time as well as computed dynamically in response to changes in market factors, performance of competitor content platforms, seasonal trends, and the like.

At S310, data on various content platforms is received. In an embodiment, received data includes data on network traffic funnels of content platforms and content performance metric values associated with the network traffic funnels. In an embodiment, one of such content platforms is the platform being monitored.

In some embodiments, data is received from analytics sources, for example, by Google® Analytics to track user activity at each step of a network traffic funnel associated with a content platform. Google Analytics provides network traffic funnel visualization reports to highlight drop-offs, behavior flow to track navigation patterns, segmented analysis, and the like. In some embodiments, data is received via tracking codes, where a user enables the code to track user activity for analytical purposes. In an embodiment, a tracking code identifies and records network traffic funnels, including how users move through webpages, where a user exits a network traffic funnel, what actions a user takes, and the like. A tracking code is a script, typically written in JavaScript and embedded within a website's HTML, that collects and transmits user interaction data.

In some embodiments, received data includes qualities of the content platforms including, but not limited to, industry, product type, market size, pricing, geographical location, user devices, traffic sources, and the like. In some embodiments, qualities of the various content platforms are received to determine semantic similarity between the various content platforms. Content platforms that have sufficient semantic similarity may be clustered together. In some embodiments, various generative AI tools are used to determine semantic similarity between content platforms. In an embodiment, semantic similarity is determined based on a word embedding model, such as Word2Vec, GloVe, and the like. In certain embodiments, semantic similarity is determined by utilizing a contextual embedding model, such as a bidirectional encoder representation from transformer (BERT) model, a generative pre-trained transformer (GPT) model, and the like.

Clustering semantically similar content platforms groups the content platforms that have, for example, but not limited to, similar industry, similar products, similar market size, and similar pricing. By aggregating the content performance metric values of the clusters of content platforms, a benchmark value can be computed for content platforms that are in similar industries, sell similar products, have similar customer bases, have similar market size, and the like. This embodiment is explained in more detail at S340.

At S320, usage groupings are generated based on similarities of usage of the various content platforms. Generating usage groupings, as explained above with respect to S230, serves to provide a segmented analysis of performance gaps by comparing content performance metric values for certain user groupings to respective benchmark values for similar or the same user groupings. As opposed to calculating benchmark values for all users in a particular network traffic funnel, generating usage groupings allows for calculating benchmark values for particular subsets of users as captured in the generated usage groupings.

As explained above, usage activities are grouped together when the usage activities have sufficiently similar attributes. Attributes include, but are not limited to, the user's device type (e.g., mobile vs. desktop), screen size, traffic source (e.g., Google search, advertisements, social media), geographical location (e.g., country, state, city), user status (e.g., returning vs. new), visit frequency (e.g., daily, weekly, monthly), and the like. In certain embodiments, an internet protocol address (IP) is utilized to track attributes from the user's activity. As mentioned above, as a non-limiting example, new users from New York City that were directed to a content platform via Instagram® on iPhone® may be a usage grouping.

At S330, for each content platform, content performance metric values are computed. Examples of content performance metrics, such as conversion rate and drop-off rate, are detailed above with respect to FIG. 1.

At S340, content performance metric values for semantically similar content platforms are aggregated. In some embodiments, aggregating content performance metric values is performed using statistical measures including, but not limited to, computing an average, median, and standard deviation. For example, aggregating conversion rates for semantically similar content platforms may include averaging conversion rates across various content platforms of a specific industry or goods (e.g., platforms that have sufficient semantic similarity). Aggregating content performance metric values for semantically similar content platforms yields a benchmark value.

In some embodiments, content performance metric values for usage groupings across semantically similar content platforms are aggregated. Aggregating content performance metric values using usage groupings as another dimension for clustering in addition to semantic similarity of content platforms serves to compute a benchmark value that is specific to particular user segment interacting with a particular type of content platform. As a non-limiting example, for shoe companies selling basketball shoes to users based in Southeast Asian via mobile applications during the playoffs of a professional basketball league, an aggregated drop-off rate for users transitioning from an add-to-cart page to a checkout page of, for example, 15% serves as the benchmark value for that content performance metric of that specific usage grouping.

In an embodiment, these benchmark values are updated continuously and dynamically in response to changes in market trends, seasonal trends, cultural trends, industry shifts, and the like, to ensure the most accurate benchmark values are computed, allowing accurate determination of performance gaps. As in the above example, a benchmark value for shoe companies selling basketball shoes to users based in Southeast Asian via mobile applications during the off-season of a professional basketball league may be 5%. The benchmark value for the same shoe companies selling the same basketball shoes to the same users via the same media may be 15% during the playoffs of the professional basketball league. This example illustrates that a benchmark value is computed dynamically.

In some embodiments, benchmark values are retrieved from an open-source database (not shown). One or more queries may be sent to the open-source database, where such queries are constructed to request benchmark values for specific web content or categories of web content. Once benchmark values are retrieved from open-source database, the benchmark values are stored, for example, in the benchmark database 170, FIG. 1. In some embodiments, a synchronization mechanism that automatically checks for updates to the open-source database at predetermined intervals may be utilized.

Although FIG. 3 shows example blocks of flowchart 300, in some implementations, flowchart 300 may include additional blocks, fewer blocks, different blocks, or differently arranged blocks than those depicted in FIG. 3. Additionally, or alternatively, two or more of the blocks of flowchart 300 may be performed in parallel.

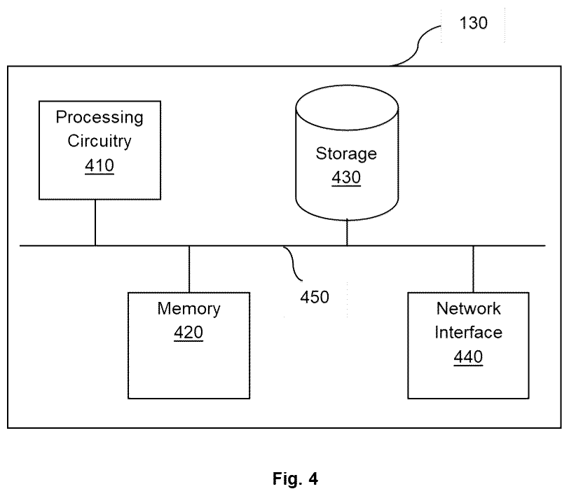

FIG. 4 is an example schematic diagram of a system 130 according to an embodiment. The system 130 includes a processing circuitry 410 coupled to a memory 420, a storage 430, and a network interface 440. In an embodiment, the components of the system 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read-only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the system 130 to communicate with, for example, the user device 120, the databases 140, and the like.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for utilizing gap analysis in web content optimization, comprising:
accessing a plurality of network traffic funnels, wherein each network traffic funnel is a series of steps navigable by a user in a content platform to reach a target outcome of a plurality of outcomes that defines a final step in the network traffic funnel;
detecting, from the plurality of network traffic funnels:
at least one first network traffic funnel, each first network traffic funnel having a target outcome of a first type and being associated with a respective content platform of a plurality of content platforms determined to be semantically similar to a primary content platform, and
a second network traffic funnel of the primary content platform, the second network traffic funnel having a second target outcome of the first type;
generating usage groupings by:
extracting usage attributes from user interactions associated with the plurality of network traffic funnels, and
segmenting the plurality of network traffic funnels based on a semantic similarity of the usage attributes;
generating, for a first usage grouping, a benchmark value of a content performance metric by aggregating content performance metric values for the at least one first network traffic funnel associated with the first usage grouping across the plurality of content platforms determined to be semantically similar to the primary content platform;
computing, for the first usage grouping and using content performance data from the second network traffic funnel, a value of the content performance metric;
detecting a content performance gap between the benchmark value and the computed value, wherein the content performance gap indicates a difference between the benchmark value and the computed value;
generating a performance gap analysis report based on a predefined markup language template and the detected content performance gap; and
sending over a network interface the generated performance gap analysis report to a client device.

2. The method of claim 1, further comprising:
generating a modified content based on the second target outcome and the benchmark value.

3. (canceled)

4. The method of claim 1, further comprising:
receiving the benchmark value of the content performance metric from a benchmark database.

5. (canceled)

6. The method of claim 1, further comprising:
embedding feature vectors representing the usage attributes into a multi-dimensional feature space, wherein the semantic similarity is
feature similarity between the feature vectors.

7. The method of claim 1, wherein the usage attributes include at least one of: time of access, device type, screen size, geographic location, navigation path, traffic source, user status, visit frequency, or interaction pattern.

8. (canceled)

9. The method of claim 1, further comprising:
identifying a usage pattern associated with the user interactions; and
detecting a network traffic funnel for each identified usage pattern.

10. The method of claim 1, wherein content performance data includes user interactions that are recorded in a plurality of activity records.

11. The method of claim 1, wherein content performance data include at least one of: a number of webpages visited, an amount of time spent on each webpage, an interaction with a content, a session ID, a heatmap, and any combination thereof.

12. The method of claim 1, wherein the target outcome includes at least one of: a click-through event, a form submission, a commitment of a transaction, a content share, a subscription, or a session duration threshold.

13. The method of claim 1, wherein the content performance metric includes at least one of: conversion rate, average time to conversion, bounce rate, or drop-off rate at a funnel step.

14. The method of claim 1, wherein generating the benchmark value of the content performance metric, further comprises:
computing, for the at least one first network traffic funnel associated with the first usage grouping across the plurality of content platforms determined to be semantically similar, the content performance metric values.

15. A non-transitory computer-readable medium storing a set of instructions for utilizing gap analysis in web content optimization, the set of instructions comprising:
one or more instructions that, when executed by one or more processors of a device, cause the device to:
access a plurality of network traffic funnels, wherein each network traffic funnel is a series of steps navigable by a user in a content platform to reach a target outcome of a plurality of outcomes that defines a final step in the network traffic funnel;
detect, from the plurality of network traffic funnels:
at least one first network traffic funnel, each first network traffic funnel having a target outcome of a first type and being associated with a respective content platform of a plurality of content platforms determined to be semantically similar to a primary content platform, and
a second network traffic funnel of the primary content platform, the second network traffic funnel having a second target outcome of the first type;
generate usage groupings by:
extracting usage attributes from user interactions associated with the plurality of network traffic funnels, and
segmenting the plurality of network traffic funnels based on a semantic similarity of the usage attributes;
generate, for a first usage grouping, a benchmark value of a content performance metric by aggregating content performance metric values for the at least one first network traffic funnel associated with the first usage grouping across the plurality of content platforms determined to be semantically similar to the primary content platform;
compute, for the first usage grouping and using content performance data from the second network traffic funnel, a value of the content performance metric;
detect a content performance gap between the benchmark value and the computed value, wherein the content performance gap indicates a difference between the benchmark value and the computed value;
generate a performance gap analysis report based on a predefined markup language template and the detected content performance gap; and
send over a network interface the generated performance gap analysis report to a client device.

16. A system for utilizing gap analysis in web content optimization comprising:
a processing circuitry;
a memory, the memory containing instructions that, when executed by the processing circuitry, configure the system to:
access a plurality of network traffic funnels, wherein each network traffic funnel is a series of steps navigable by a user in a content platform to reach a target outcome of a plurality of outcomes that defines a final step in the network traffic funnel;
detect, from the plurality of network traffic funnels:
at least one first network traffic funnel, each first network traffic funnel having a target outcome of a first type and being associated with a respective content platform of a plurality of content platforms determined to be semantically similar to a primary content platform, and
a second network traffic funnel of the primary content platform, the second network traffic funnel having a second target outcome of the first type;
generate usage groupings by:
extracting usage attributes from user interactions associated with the plurality of network traffic funnels, and
segmenting the plurality of network traffic funnels based on a semantic similarity of the usage attributes;
generate, for a first usage grouping, a benchmark value of a content performance metric by aggregating content performance metric values for the at least one first network traffic funnel associated with the first usage grouping across the plurality of content platforms determined to be semantically similar to the primary content platform;
compute, for the first usage grouping and using content performance data from the second network traffic funnel, a value of the content performance metric;
detect a content performance gap between the benchmark value and the computed value, wherein the content performance gap indicates a difference between the benchmark value and the computed value;
generate a performance gap analysis report based on a predefined markup language template and the detected content performance gap; and
send over a network interface the generated performance gap analysis report to a client device.

17. The system of claim 16, wherein the memory contains further instructions which when executed by the processing circuitry further configure the system to:
generate a modified content based on the second target outcome and the benchmark value.

18. (canceled)

19. The system of claim 16, wherein the memory contains further instructions which when executed by the processing circuitry further configure the system to:
receive the benchmark value of the content performance metric from a benchmark database.

20. (canceled)

21. The system of claim 16, wherein the memory contains further instructions which when executed by the processing circuitry further configure the system to:
embed feature vectors representing the usage attributes into a multi-dimensional feature space, wherein the semantic similarity is
feature similarity between the feature vectors.

22. (canceled)

23. The system of claim 16, wherein the memory contains further instructions which when executed by the processing circuitry further configure the system to:
identify a usage pattern associated with the user interactions; and
detect a network traffic funnel for each identified usage pattern.

24. The system of claim 16, wherein content performance data includes user interactions that are recorded in a plurality of activity records.

25. The system of claim 16, wherein content performance data include at least one of:
a number of webpages visited, an amount of time spent on each webpage, an interaction with a content, a session ID, a heatmap, and any combination thereof.

26. The system of claim 16, wherein the target outcome includes at least one of:
a click-through event, a form submission, a commitment of a transaction, a content share, a subscription, or a session duration threshold.

27. The system of claim 16, wherein the content performance metric includes at least one of:
conversion rate, average time to conversion, bounce rate, or drop-off rate at a funnel step.

28. The system of claim 16, wherein the memory contains further instructions that, when executed by the processing circuitry for generating the benchmark value of the content performance metric, further configure the system to:
compute, for the at least one first network traffic funnel associated with the first usage grouping across the plurality of content platforms determined to be semantically similar, the content performance metric values.
